(19) United States
(12) Patent Application Publication
(10) Pub. No.: US 2010/0039890 A1
(43) Pub. Date: Feb. 18, 2010

(54) SEISMIC DATA ACQUISITION ASSEMBLY

(76) Inventors: Gary John Tustin, Sawston (GB); Gerald Henry Meeten, Ware (GB); Timothy G.J. Jones, Cottenham (GB); Valerie Anderson, Cambridge (GB); Oeystein Traetten, Asker (NO); Henk Keers, Oslo (NO); Ottar Kristiansen, Oslo (NO); Nils Halvor Heieren, Oslo (NO); Leendert Combee, Sandvika (NO); Bent Andreas Kjellesvig, Rasta (NO)

Correspondence Address: WesternGeco L.L.C.;Kevin McEnaney, 10001 Richmond Avenue, HOUSTON, TX, 77042-4299, US

(21) Appl. No.: 12/193,112

(22) Filed: Aug. 18, 2008

(51) Int. Cl. G01V 1/16

(52) U.S. Cl. 367/20

(57) ABSTRACT

A seismic data acquisition assembly includes a cable; seismic sensors that are disposed along the cable; and a filler material inside the cable. The filler includes a hydrocarbon-based liquid and an agent to cause the filler material to have a rheological property that is substantially different than a corresponding rheological property of the hydrocarbon-based liquid.

### BACKGROUND

The invention generally relates to a seismic data acquisition assembly, such as a streamer.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a seismic data acquisition assembly includes a cable; seismic sensors that are disposed along the cable; and a filler material inside the cable. The filler material includes a hydrocarbon-based liquid and an agent to cause the filler material to have a rheological property that is substantially different than a corresponding rheological property of the hydrocarbon-based liquid.

In another embodiment of the invention, a seismic data acquisition assembly includes a cable; seismic sensors that are disposed along the cable; and a filler material inside the cable. The filler material includes an oil swollen oleogel.

In another embodiment of the invention, a seismic data acquisition assembly includes a cable; seismic sensors that are disposed along the cable; and a filler material inside the cable. The filler material includes a surfactant.

In another embodiment of the invention, a seismic data acquisition assembly includes a cable; and seismic sensors that are disposed along the cable. The cable includes an outer skin and a layer inside the skin, which is adapted to react to water that leaks through an opening in the skin to seal the opening.

In yet another embodiment of the invention, a seismic data acquisition assembly includes a cable; seismic sensors that are disposed along the cable; and a filler material inside the cable. The filler material includes crosslinked gel particles that are suspended in a fluid. The crosslinked gel particles are associated with a size that is small enough to allow the filler material to be pumped into an interior space of the cable and large enough to prevent the filler material from leaking through an outer skin of the cable upon puncture of the skin.

Advantages and other features of the invention will become apparent from the following drawing, description and claims.

### BRIEF DESCRIPTION OF THE DRAWING

FIG. 1 is a schematic diagram of a marine seismic data acquisition system according to an embodiment of the invention.

FIG. 2 depicts a cross-sectional view of a streamer taken along line 2-2 of FIG. 1 according to an embodiment of the invention.

FIGS. 3, 4, 5 and 7 are flow diagrams depicting techniques to construct a seismic sensor streamer according to embodiments of the invention.

FIG. 6 depicts a cross-sectional view of a streamer according to another embodiment of the invention.

### DETAILED DESCRIPTION

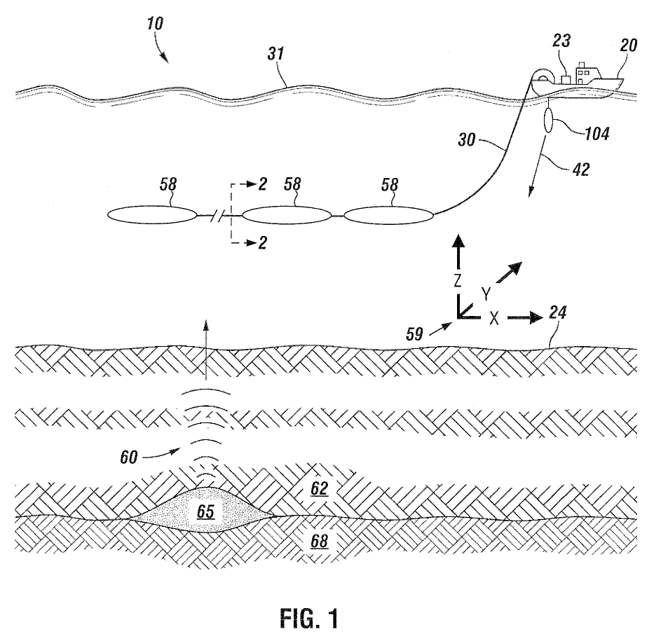

FIG. 1 depicts an embodiment 10 of a marine seismic data acquisition system in accordance with some embodiments of the invention. In the system 10, a survey vessel 20 tows one or more seismic streamers 30 (one exemplary streamer 30 being depicted in FIG. 1) behind the vessel 20. The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors 58 that record seismic signals.

In accordance with embodiments of the invention, the seismic sensors 58 may be pressure sensors only or may be multi-component seismic sensors. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the seismic sensor. It is noted that the multi-component seismic sensor may be implemented as a single device or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes a seismic source 104 that may be formed from one or more seismic source elements, such as air guns, for example, which are connected to the survey vessel 20. Alternatively, in other embodiments of the invention, the seismic source 104 may operate independently of the survey vessel 20, in that the seismic source 104 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source 104 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion (if the sensors are particle motion sensors). The traces are recorded and may be at least partially processed by a signal processing unit 23 that is deployed on the survey vessel 20, in accordance with some embodiments of the invention. For example, a particular multi-component seismic sensor may provide a trace, which corresponds to a measure of a pressure wavefield by its hydrophone; and the sensor may provide one or more traces that correspond to one or more components of particle motion, which are measured by its accelerometers.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23.

The seismic sensors 58 typically are uniformly spaced along a streamer 30. In addition to the seismic sensors 58, the streamer 30 includes additional members, such as stress members, electric wiring, etc. All of these parts have a density that is greater than the density of water. In order for the streamer 30 to remain buoyant, the remainder of space inside the streamer 30 is filled with a filler material, which has a density less than the density of water.

Conventionally, the filler material may be kerosene or gel. Alternatively, the streamer 30 may be “solid,” an arrangement in which only the portions of the streamer that surround the seismic sensors 58 are filled with fluid (as the sensors are surrounded by fluid), and the rest of the streamer 30 is solid.

Kerosene typically has been widely used in the past as a filler material due to kerosene having a density that is less than water, being relatively inexpensive and having acoustic properties that are very similar to that of water. However, the use of kerosene as a filler material presents several challenges. A primary challenge in using kerosene as a filler material is that kerosene is environmentally unfriendly. For example, if the streamer 30 breaks or becomes damaged during operations (becomes damaged due to a shark bite, for example), some of the kerosene may leak into the sea water, thereby potentially causing environmental damage. Additionally, a challenge in using kerosene as a filler material is that damage to the electrical wiring of the streamer 30 may cause an electrical shortage when the wiring contacts water that includes the damaged streamer 30.

Gel is another filler material that is conventionally used as an alternative to kerosene. The gel may be a cross-linked polymer, which has a viscosity that is considerably higher than that of kerosene. Therefore, the gel generally does not leak should the streamer 30 become damaged.

A potential challenge with the use of gel as a filler material is the relatively long curing time for the gel. In this regard, after the streamer 30 is filled with gel, the streamer 30 may need to be kept under tension for several weeks at the manufacturer in order for the gel to cure. Such a process may be cumbersome, time consuming and expensive. Another challenge associated with the use of a gel as the filler material is that small air bubbles may be trapped in the streamer 30. These air bubbles, in turn, may significantly undermine the acoustic properties of the streamer 30, especially when the bubbles are near the seismic sensors 58.

For purposes of overcoming the above-mentioned challenges in using gel as a filler material, a thermal gel may be used that has a temperature-dependent viscosity. In other words, the thermal gel is a liquid when filled into the streamer 30 at higher temperatures, and the thermal gel becomes a fluid when the streamer is in water. Ultraviolet radiation may also be applied to the gel for purposes of reducing the gel's viscosity to fill the streamer with the gel. These techniques may also encounter various challenges.

In accordance with embodiments of the invention, various filler materials for streamers are described herein, which have generally sufficient acoustic properties, are relatively easy to introduce into the streamer and are constructed to prevent leaks and air bubbles.

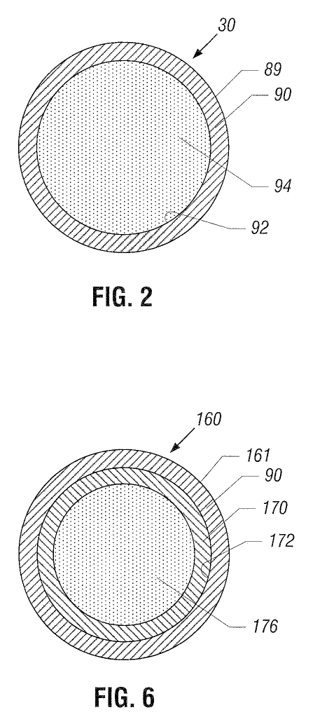

As a specific example, FIG. 2 depicts a cross-sectional view of the streamer 30, in accordance with some embodiments of the invention, in a portion of the streamer 30 which does not contain a stress spacer or sensor element. Furthermore, for clarity, various other features of the streamer 30, such as optical fibers, electrical wires, support members, etc., which are part of the streamer 30 are not depicted in the cross-sectional view. The streamer 30 includes a primary cable 89 that has an outer skin 90 (a hard plastic, such as polyurethane, for example), which defines an interior space 92 inside the cable 89. As shown, the interior space 92 contains a filler material 94.

In accordance with some embodiments of the invention, the filler material 94 includes a hydrocarbon-based liquid, such as kerosene, which has a modified rheology (i.e., a rheology different from the rheology of the hydrocarbon-based liquid) to enhance the properties of the filler material 94. For example, in accordance with some embodiments of the invention, the filler material 94 includes kerosene and an agent, such as a viscosifier, to modify the rheology of the kerosene. As a more specific example, the viscosifier may be a low-cost butadiene, such as paratac, for example. Paratac, in general, increases the viscosity of the kerosene, without giving rise to problems associated with gels, such as bubbles or gelling. Furthermore, when the filler material 94 is formed from kerosene and a rheology-modifying agent, such as paratac, the filling of the streamer 30 takes significantly less time and effort, as compared to the use of a gel as the filler material. The amount of viscosifier added determines the viscosity of the filler material 94.

An important property of certain viscosifiers, such as paratac, is that the viscosifier may have a tendency to solidify when the viscosifier contacts water. Such a property allows the viscosifier to significantly limit the amount of the filler material 94, which leaks into the surrounding sea water should the streamer 30 break or rupture, thereby preventing environmental damage. An added advantage of the filler material 94 is that the filler material 94 may reduce swelling and weakening of the skin 90, as compared to the swelling and weakening that is caused by the use of relatively pure kerosene as the filler material. An additional advantage of using a rheology-modifying agent with the hydrocarbon-based liquid is that the agent may also serve as a tackifier, which reduces water creep at the surfaces of the skin 90.

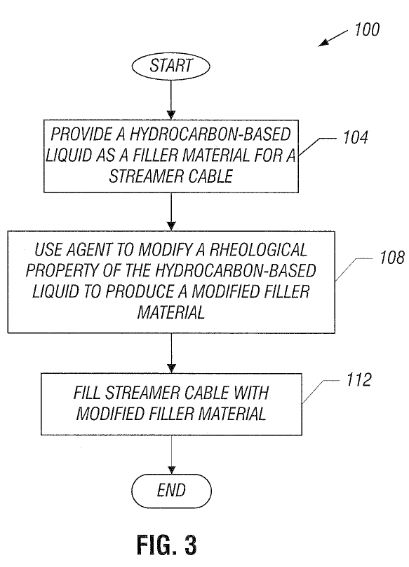

Referring to FIG. 3, to summarize, a technique 100 in accordance with embodiments of the invention includes providing (block 104) a hydrocarbon-based liquid, such as kerosene, as a filler material for a streamer cable. An agent is used (block 108) to modify a rheological property of the hydrocarbon-based liquid to produce a modified filler material. Thus, the modified filler material may have an increased viscosity and/or an increased elasticity, as compared to the hydrocarbon-based liquid, in accordance with embodiments of the invention. The streamer cable is filled, pursuant to block 112, with the modified filler material.

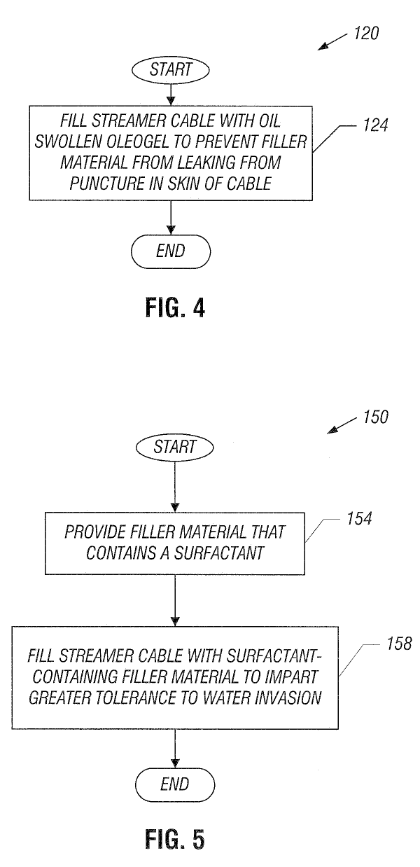

Referring back to FIG. 2, in accordance with another embodiment of the invention, the filler material 94 may be an oil swollen oleogel. The oleogel is generated in such as way that the oleogel does not trap air and does not leak if the streamer 30 is punctured, thereby reducing environmental damage. Thus, referring to FIG. 4 in conjunction with FIG. 2, in accordance with some embodiments of the invention, a technique 120 includes filling (block 124) a streamer cable with an oil swollen oleogel to prevent leakage of the filler material in the event that the streamer's skin 90 is punctured or ruptured.

Referring to FIG. 2, as another alternative, in accordance with some embodiments of the invention, the filler material 94 may be a solution of a hydrocarbon-based liquid, such as kerosene, and an oil soluble surfactant, such as aerosol AOT, which is dissolved in the hydrocarbon-based liquid. Such a filler material is less sensitive to electrical shortage because the surfactant encapsulates invading water droplets in micelles, effectively rendering the invading water droplets inert. Therefore, the use of the surfactant containing filler material 94 produces a streamer 30 that has a greater tolerance to water, as compared to a streamer that contains a pure kerosene-based filler material, for example.

Referring to FIG. 5, to summarize, a technique 150 in accordance with an embodiment of the invention includes providing (block 154) a filler material that contains a surfactant and filling a streamer cable (block 158) with the filler material to give the streamer greater tolerance to water invasion.

FIG. 6 depicts an exemplary cross-sectional view of another streamer 160 in accordance with another embodiment of the invention. For purposes of clarity, the cross-sectional view omits certain structural and communication components of the streamer 160, such as support members, optical fibers, electrical lines, etc. In general, the streamer 160 includes a primary cable 161 that contains various seismic sensors that may be disposed along the length of the cable 161. The cable 161 has an outer skin 90 (a polyurethane material, for example) and an interior space 172 that contains a filler material 176.

Unlike the streamers disclosed above, the primary cable 161 of the streamer 160 includes an inner layer 170, which lines the interior surface of the skin 90 for purposes of resealing any damage to the skin 90. As a more specific example, in accordance with some embodiments of the invention, the inner layer 170 is a chlorosilicon layer, which adheres to the interior surface of the skin 90. The chlorosilicon layer is inert with respect to the filler material 176 inside the interior space of the streamer 160.

As a non-limiting example, the filler material 176 may be a relatively environmentally unfriendly material, such as kerosene. However, when the skin 90 is breached, the invading water hydrolyzes with the chlorosilicon layer 170 to create a polysilicate, which reseals the damage, thereby preventing leakage of the filler material 176. Additionally, the use of the inner layer 170 reduces the degree of degradation that may be caused to the skin 90 due to the skin 90 being in contact with the filler material 176 for an extended period of time.

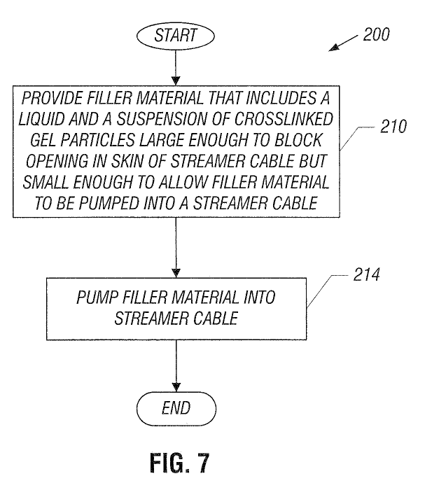

Referring back to FIG. 2, in other embodiments of the invention, in lieu of the inner layer 172 (see FIG. 6), the filler material 94 may contain lightly crosslinked gel particles, which are suspended in a suitable fluid. The particles have a sufficiently small size to be pumped into the interior space 92 of the streamer 30. However, the particles are sufficiently large enough to block holes in the skin 90. Therefore, referring to FIG. 7 in conjunction with FIG. 2, in accordance with embodiments of the invention, a technique 200 includes providing (block 210) a filler material that includes crosslinked gel particles that are large enough to block openings in the skin of a streamer cable but are small enough to allow filler material to be pumped into the streamer 30 without significantly changing the temperature of the filler material. The filler material may be pumped into the streamer 30, pursuant to block 214.

The techniques and structures that are disclosed herein may be used not only in narrow azimuth surveys but also in wide azimuth surveys and surveys in the transition zone. Initially, in accordance with embodiments of the invention, the techniques and structures that are disclosed herein may likewise be applied to any type of seismic acquisition platform that employs a cable, such as a seabed cable, for example. Thus, many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A seismic data acquisition assembly, comprising:
a cable;
seismic sensors that are disposed along the cable; and
a filler material inside the cable, the filler material comprising a hydrocarbon-based liquid and an agent to cause the filler material to have a rheological property that is substantially different from a corresponding rheological property of the hydrocarbon-based liquid.

2. The seismic data acquisition assembly of claim 1, wherein the hydrocarbon-based liquid comprises kerosene.

3. The seismic data acquisition assembly of claim 1, wherein the agent comprises a viscosifier.

4. The seismic data acquisition assembly of claim 3, wherein the viscosifier comprises butadiene.

5. The seismic data acquisition assembly of claim 1, wherein the agent is adapted to solidify in response to the agent contacting water.

6. The seismic data acquisition assembly of claim 1, wherein the agent comprises a tackifier.

7. The seismic data acquisition assembly of claim 1, wherein the assembly comprises a streamer or a seabed sensor cable.

8. A seismic data acquisition assembly, comprising:
a cable;
seismic sensors that are disposed along the cable; and
a filler material inside the cable, the filler material comprising an oil swollen oleogel.

9. The seismic data acquisition assembly of claim 8, wherein the assembly comprises a streamer or a seabed sensor cable.

10. A seismic data acquisition assembly, comprising:
a cable;
seismic sensors that are disposed along the cable; and
a filler material inside the cable, the filler material comprising a surfactant.

11. The seismic data acquisition assembly of claim 10, wherein the surfactant is adapted to encapsulate water that enters an interior space of the cable.

12. The seismic data acquisition assembly of claim 10, wherein the filler material comprises a hydrocarbon-based liquid and the surfactant is dissolved in the liquid.

13. The seismic data acquisition assembly of claim 12, wherein the hydrocarbon-based liquid comprises kerosene.

14. The seismic data acquisition assembly of claim 10, wherein the surfactant comprises aerosol AOT.

15. The seismic data acquisition assembly of claim 10, wherein the assembly comprises a streamer or a seabed sensor cable.

16. A seismic data acquisition assembly, comprising:
a cable; and
seismic sensors disposed along the cable, wherein the cable includes an outer skin and a layer inside the skin adapted to react to water that leaks through an opening in the skin to seal the opening.

17. The seismic data acquisition assembly of claim 16, wherein the layer comprises chlorosilicon.

18. The seismic data acquisition assembly of claim 17, wherein the chlorosilicon is adapted to hydrolyze in response to the water than leaks through the opening to form polysilicate to seal the opening.

19. The seismic data acquisition assembly of claim 16, further comprising:
a hydrocarbon-based filler liquid inside the cable.

20. The seismic data acquisition assembly of claim 16, wherein the outer skin comprises polyurethane.

21. The seismic data acquisition assembly of claim 16, wherein the assembly comprises a streamer or a seabed sensor cable.

22. A seismic data acquisition assembly, comprising:
a cable comprising an outer skin;
seismic sensors disposed along the cable; and
a filler material comprising crosslinked gel particles suspended in a fluid, the crosslinked gel particles being associated with a size that is small enough to allow the filler to be pumped into an interior space of the cable and large enough to prevent the filler from leaking from the skin upon puncture of the skin.

23. The seismic data acquisition assembly of claim 22, wherein the assembly comprises a streamer or a seabed sensor cable.
